(19) United States
(12) Patent Application Publication
(10) Pub. No.: US 2026/0302242 A1
(43) Pub. Date: Oct. 1, 2026

(54) ELECTRODE BINDER FOR SECONDARY BATTERY INCLUDING SECONDARY-BATTERY ELECTRODES INCLUDING CARBON NANOTUBES, AND USES THEREOF

(71) Applicant: TOAGOSEI CO., LTD, Tokyo (JP)

(72) Inventors: Mei UCHIYAMA, Tokyo (JP); Naohiko SAITO, Tokyo (JP); Takashi HASEGAWA, Tokyo (JP)

(73) Assignee: TOAGOSEI CO., LTD, Tokyo (JP)

(21) Appl. No.: 19/474,081

(22) PCT Filed: Apr. 5, 2024
(86) PCT No.: PCT/JP2024/014034

§ 371 Date: Oct. 9, 2025

(30) Foreign Application Priority Data
Apr. 10, 2023 (JP) 2023-063756

(51) Int. Cl. H01M 4/62; H01M 4/134; H01M 4/38

(52) U.S. Cl. CPC H01M 4/622; H01M 4/134; H01M 4/386; H01M 4/625

(57) ABSTRACT

The present invention provides a binder for a secondary battery electrode capable of exhibiting a high capacity retention rate while suppressing expansion and shrinkage due to charge and discharge in use for a longer period of time than before even when using a silicon-based active material which is considered to have large expansion and shrinkage due to charge and discharge. In addition, provided are a composition for a secondary battery electrode mixture layer containing the binder, and a secondary battery electrode and a secondary battery obtained using the composition. A binder for an electrode of a secondary battery provided with a secondary battery electrode containing carbon nanotubes, the binder for the electrode containing a carboxyl group-containing non-crosslinked polymer or a salt of the non-crosslinked polymer, in which a degree of neutralization of the polymer is 50 mol % or more.

### TECHNICAL FIELD

The present invention relates to a binder for an electrode of a secondary battery provided with a secondary battery electrode containing carbon nanotubes, and use thereof.

### BACKGROUND ART

As the secondary battery, various power storage devices such as a nickel-hydrogen secondary battery, a lithium ion secondary battery, and an electric double layer capacitor have been put into practical use. Electrodes used in these secondary batteries are prepared by, for example, applying and drying a composition for forming an electrode mixture layer containing an active material, a binder, and the like onto a current collector. For example, in the lithium ion secondary battery, an aqueous binder containing styrene-butadiene rubber (SBR) latex and carboxymethyl cellulose (CMC) is used as a binder used in a composition for a negative electrode mixture layer. Further, as a binder excellent in dispersibility and binding property, a binder containing an aqueous solution or an aqueous dispersion of an acrylic acid-based polymer is known. On the other hand, as a binder used for a positive electrode mixture layer, an N-methyl-2-pyrrolidone (NMP) solution of polyvinylidene fluoride (PVDF) is widely used.

In recent years, as applications of various secondary batteries expand, demands for improvement in energy density, reliability, and durability tend to increase. For example, specifications using a silicon-based active material as an active material for a negative electrode have been increasing for the purpose of increasing electric capacity of the lithium ion secondary battery. However, it is known that the silicon-based active material has a large volume change during charge and discharge, and there has been a problem that peeling, falling off, or the like of the electrode mixture layer occurs as the silicon-based active material is repeatedly used, and as a result, the capacity of the battery decreases, and cycle characteristics (durability) deteriorate. In order to suppress such a problem, it is generally effective to enhance the binding property of the binder, and for the purpose of improving durability, studies on improvement of the binding property of the binder have been conducted.

As a binder having good binding property and exerting an effect of improving durability, a binder using the acrylic acid-based polymer has been proposed, and it is known that electrical contact between active materials is improved and battery performance is improved by adding a conductive auxiliary agent to a slurry for producing a negative electrode.

For example, Patent Literatures 1 and 2 disclose that an electrode obtained by an electrode mixture layer composition containing an active material containing silicon, a conductive auxiliary agent, and a binder containing a monomer unit derived from acrylic acid and a monomer unit having a specific structure has an excellent charge/discharge capacity. It is specifically described that by using Ketjen black or acetylene black as the conductive auxiliary agent, a capacity retention rate after 10 cycles or 30 cycles of charge and discharge is high.

### CITATION LIST

### Patent Literature

Patent Literature 1: WO 2015/163302A
Patent Literature 2: JP-A-2018-029069

### SUMMARY OF INVENTION

### Problems to be Solved by Invention

Both of the binders disclosed in Patent Literatures 1 and 2 can impart good binding property, and as described above, when the number of charge/discharge cycles is as small as about 10 to 30 cycles, a high capacity retention rate can be exhibited, but there has been a problem that structural deterioration of the negative electrode due to expansion and shrinkage of the silicon-based active material increases every time charge and discharge are repeated, a conductive path between the active materials cannot be retained, and capacity deterioration is caused.

The present invention has been made in view of such circumstances, and an object of the present invention is to provide a binder for a secondary battery electrode capable of exhibiting a high capacity retention rate while suppressing expansion and shrinkage due to charge and discharge in use for a longer period of time than before even when using a silicon-based active material which is considered to have large expansion and shrinkage due to charge and discharge. In addition, another object of the present invention is to provide a composition for a secondary battery electrode mixture layer containing the binder, and a secondary battery electrode and a secondary battery obtained using the composition.

### Solution to Problems

As a result of intensive studies to solve the above problems, the present inventors have found that when a binder containing a carboxyl group-containing non-crosslinked polymer or a salt thereof is used as a binder for an electrode of a secondary battery provided with a secondary battery electrode containing carbon nanotubes (hereinafter, also referred to as “CNT”) as a conductive auxiliary agent, and a degree of neutralization of the polymer is set to a specific value or more, an excellent charge/discharge capacity retention rate can be exhibited while expansion and shrinkage due to charge and discharge is suppressed even when the secondary battery is used at a higher number of cycles than before, and have completed the present invention.

The present invention is as follows.
[1] A binder for an electrode of a secondary battery provided with a secondary battery electrode containing carbon nanotubes, the binder for the electrode containing a carboxyl group-containing non-crosslinked polymer or a salt of the non-crosslinked polymer, wherein a degree of neutralization of the polymer is 50 mol % or more.
[2] The binder for the electrode according to [1], in which the carboxyl group-containing non-crosslinked polymer contains a structural unit derived from an ethylenically unsaturated carboxylic acid monomer in an amount of 50 mass % or more and 100 mass % or less with respect to all structural units of the carboxyl group-containing non-crosslinked polymer.
[3] A composition for a secondary battery electrode mixture layer, the composition including the binder for the electrode according to [1] or [2], a carbon nanotube, an active material, and water.
[4] The composition for the secondary battery electrode mixture layer according to [3], in which a content of a silicon active material is 5.0 mass % or more with respect to a total amount of the active material.
[5] The composition for the secondary battery electrode mixture layer according to [3] or [4], in which a content of the binder for the electrode is 1.0 part by mass or more and 2.5 parts by mass or less with respect to 100 parts by mass of a total amount of the active material.
[6] The composition for the secondary battery electrode mixture layer according to any one of [3] to [5], in which a content of the carbon nanotube is 0.1 part by mass or more with respect to 100 parts by mass of a total amount of the active material.
[7] The composition for the secondary battery electrode mixture layer according to any one of [3] to [6], in which the carbon nanotube has a single-layer structure.
[8] A secondary electrode including a mixture layer formed from the composition for the secondary battery electrode mixture layer according to any one of [3] to [7] on a surface of a current collector.
[9] A secondary battery including the secondary electrode according to [8].

### Effects of Invention

With the binder for the electrode of the present invention, it is possible to obtain a secondary battery that exhibits an excellent charge/discharge capacity retention rate while suppressing expansion and shrinkage due to charge and discharge in use for a longer period of time than before.

### DESCRIPTION OF EMBODIMENTS

A binder for a secondary battery electrode (hereinafter, also referred to as “the present binder”) of the present invention contains a carboxyl group-containing non-crosslinked polymer (hereinafter, also referred to as “the present non-crosslinked polymer”) or a salt thereof (hereinafter, also referred to as “the present non-crosslinked polymer salt”), and can be mixed with carbon nanotubes (hereinafter, also referred to as “CNT”), an active material, and water to form a composition for a secondary battery electrode mixture layer (hereinafter, also referred to as “the present composition”). The above composition is preferably an electrode slurry in a slurry state capable of being applied to a current collector from the viewpoint of exerting an effect of the present invention, but may be prepared in a wet powder state so as to be able to cope with press working on a surface of the current collector. A secondary battery electrode of the present invention is obtained by forming a mixture layer formed of the above composition on the surface of the current collector such as a copper foil or an aluminum foil.

Here, when the present binder is used in the composition for the secondary battery electrode mixture layer containing a silicon-based active material described later as the active material, it is preferable from the viewpoint that the effect obtained by the present invention is particularly large.

Hereinafter, the carbon nanotubes, the present non-crosslinked polymer and a method for producing the same, the composition for the secondary battery electrode mixture layer obtained using the present binder, the secondary battery electrode, and a secondary battery will be respectively described in detail.

Note that in the present specification, “(meth)acryl” means acryl and/or methacryl, and “(meth)acrylate” means acrylate and/or methacrylate. Further, “(meth)acryloyl group” means acryloyl group and/or methacryloyl group.

In numerical ranges described in stages in the present specification, an upper limit value or a lower limit value described in one numerical range may be replaced with an upper limit value or a lower limit value of a numerical range described in other stages, and the upper limit value or the lower limit value of the numerical range may be replaced with a value shown in Examples.

### 1. Carbon Nanotube

The carbon nanotube (CNT) used in the present composition has high conductivity and chemical stability, and is used as a conductive auxiliary agent for ensuring electrical contact between active materials in the electrode mixture layer. The CNT has a shape in which planar graphite is wound in a cylindrical shape, the type of the CNT is not particularly limited, and a CNT having a single-layer structure (hereinafter, also referred to as a “single-walled CNT”), a CNT having a multi-layer structure (hereinafter, also referred to as “multi-walled CNT”), or the like can be used. These can be used alone or in combination of two or more types thereof.

As the CNT, it is preferable to contain the single-walled CNT from the viewpoint that the effect obtained by the present invention is particularly large.

The single-walled CNT has a structure in which one layer of graphite is wound, and the multi-walled CNT has a structure in which two or three or more layers of graphite are wound.

Here, a sidewall of the CNT may not have a graphite structure, and a CNT including a sidewall having an amorphous structure is also the CNT in the present specification.

The shape of the CNT is not limited. Examples of such a shape include various shapes including a needle shape, a cylindrical tube shape, a fishbone shape (fishbone or cup lamination type), a trump shape (platelet), and a coil shape. Among them, the shape of the CNT is preferably a needle shape or a cylindrical tube shape. The CNT may have a single shape or a combination of two or more shapes.

Examples of the form of the CNT include graphite whisker, filamentous carbon, graphite fiber, ultrafine carbon tube, carbon tube, carbon fibril, carbon microtube, and carbon nanofiber. The CNT may be in a single form or a combination of two or more forms.

An average outer diameter of CNTs is preferably 1 nm or more, and more preferably 5 nm or less. Further, the average outer diameter is still more preferably 3 nm or less. Note that the average outer diameter of the CNTs can be calculated by first observing and imaging the CNTs with a transmission electron microscope, selecting arbitrary 300 CNTs in an observation photograph, and measuring outer diameters of the CNTs.

An average fiber length of the CNTs is preferably 0.5 μm or more, more preferably 0.8 μm or more, still more preferably 1.0 μm or more, and even more preferably 5.0 μm or more. Further, the average fiber length is preferably 20 μm or less, and more preferably 10 μm or less. Note that the average fiber length of the CNTs can be calculated by first observing and imaging the CNTs with a scanning electron microscope, selecting arbitrary 300 CNTs in an observation photograph, and measuring fiber lengths of the CNTs.

A value obtained by dividing the fiber length of the CNT by the outer diameter is an aspect ratio. A representative aspect ratio can be determined using values of the average fiber length and the average outer diameter.

The conductive auxiliary agent having a higher aspect ratio can obtain higher conductivity when an electrode is formed, and the aspect ratio of the CNT is preferably 30 or more, more preferably 50 or more, and still more preferably 80 or more. In addition, the aspect ratio is preferably 10,000 or less, more preferably 3,000 or less, and still more preferably 1,000 or less.

Specific surface area of the CNTs is preferably 100 m²/g or more, more preferably 150 m²/g or more, and still more preferably 200 m²/g or more. Further, the specific surface area is preferably 1200 m²/g or less, and more preferably 1000 m²/g or less. Note that the specific surface area of the CNTs can be calculated by BET method based on nitrogen adsorption measurement.

When the average outer diameter, the average fiber length, the aspect ratio, and the specific surface area of the CNTs are within the above ranges, it is easy to form a conductive path developed in the electrode.

Carbon purity of the CNT is expressed as the content (mass %) of carbon atoms in the CNTs. The carbon purity is preferably 80 mass % or more, more preferably 90 mass % or more, still more preferably 95 mass % or more, and particularly preferably 98 mass % or more with respect to 100 mass % of the CNTs. By setting the carbon purity within the above range, it is possible to prevent problems such as short circuit caused by formation of dendrite due to impurities such as a metal catalyst.

The CNTs may be surface-treated CNTs. The CNT may be a CNT derivative to which a functional group represented by a carboxy group is added. In addition, the CNTs containing a substance represented by an organic compound, a metal atom, or fullerene can also be used.

The CNTs can be produced by a laser ablation method, an arc discharge method, a thermal CVD method, a plasma CVD method, and a combustion method, but are not limited thereto. For example, the CNTs can be produced by subjecting a carbon source to a catalytic reaction with a catalyst at 500 to 1000° C. in an atmosphere having an oxygen concentration of 1 vol % or less.

The carbon source may be at least one of a hydrocarbon and an alcohol.

### 2. The Present Non-Crosslinked Polymer

The present non-crosslinked polymer can have a structural unit (hereinafter, also referred to as “component (a)”) derived from an ethylenically unsaturated carboxylic acid monomer, and a monomer component containing the component (a) can be introduced into a polymer by polymerization.

<Structural Unit Derived from Ethylenically Unsaturated Carboxylic Acid Monomer>

The carboxyl group-containing non-crosslinked polymer (The present non-crosslinked polymer) contained in the present binder may have a structural unit (hereinafter, also referred to as “component (a)”) derived from an ethylenically unsaturated carboxylic acid monomer. When the present non-crosslinked polymer has a carboxyl group by having such a structural unit, adhesiveness to the current collector is improved, and a lithium ion desolvation effect and ion conductivity are excellent, so that an electrode having low resistance and excellent high-rate characteristics can be obtained. In addition, it is considered that since a polymer chain has a spread conformation in water, dispersion stability of the active material and the like in the present composition can be enhanced.

The component (a) can be introduced into a polymer by, for example, polymerizing a monomer containing an ethylenically unsaturated carboxylic acid monomer. In addition, the component (a) is also obtained by (co) polymerizing a (meth)acrylic acid ester monomer and then hydrolyzing it. In addition, (meth)acrylamide, (meth)acrylonitrile, or the like may be polymerized and then treated with a strong alkali, or a method of reacting an acid anhydride with a polymer having a hydroxyl group may be used.

Examples of the ethylenically unsaturated carboxylic acid monomer include: (meth)acrylic acid, itaconic acid, crotonic acid, maleic acid, and fumaric acid; (meth)acrylamidoalkyl carboxylic acid such as (meth)acrylamidohexanoic acid and (meth)acrylamidododecanoic acid; and carboxyl group-containing ethylenically unsaturated monomers such as succinic acid monohydroxyethyl (meth)acrylate, ω-carboxy-caprolactone mono(meth)acrylate, and β-carboxyethyl (meth)acrylate, and (partially) alkali-neutralized products thereof, and one of them may be used alone, or two or more thereof may be used in combination. Among the above, a compound having an acryloyl group as a polymerizable functional group is preferable, and acrylic acid is particularly preferable, from the viewpoint that a polymer having a long primary chain length is obtained due to a high polymerization rate and binding force of the binder is improved. When acrylic acid is used as the ethylenically unsaturated carboxylic acid monomer, a polymer having a high carboxyl group content can be obtained.

The content of the component (a) in the present non-crosslinked polymer can range from 50 mass % to 100 mass % with respect to all structural units of the present non-crosslinked polymer. By containing the component (a) within such a range, excellent adhesiveness to the current collector can be easily secured. When the lower limit is 50 mass % or more, dispersion stability of the present composition is good, and a higher binding force is obtained, which is preferable, and the lower limit may be 60 mass % or more, 70 mass % or more, or 80 mass % or more. Further, the upper limit is, for example, 99.9 mass % or less, for example, 99.5 mass % or less, for example, 99 mass % or less, for example, 98 mass % or less, for example, 95 mass % or less, for example, 90 mass % or less, or for example, 80 mass % or less.

### <Other Structural Units>

The present non-crosslinked polymer can contain, in addition to the component (a), a structural unit (hereinafter, also referred to as “component (b)”) derived from another ethylenically unsaturated monomer copolymerizable therewith. Examples of the component (b) include a structural unit derived from a hydroxyl group-containing ethylenically unsaturated monomer (monomer represented by the following formula (1) and monomer represented by formula (2)), an ethylenically unsaturated monomer compound having an anionic group other than a carboxyl group, such as a sulfonic acid group and a phosphoric acid group, a nonionic ethylenically unsaturated monomer, or the like. These structural units can be introduced by copolymerizing the hydroxyl group-containing ethylenically unsaturated monomer, the ethylenically unsaturated monomer compound having an anionic group other than a carboxyl group, such as a sulfonic acid group and a phosphoric acid group, or monomers including the nonionic ethylenically unsaturated monomer.

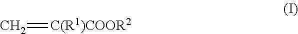

[where R¹ represents a hydrogen atom or a methyl group, and R² represents a monovalent organic group having a hydroxyl group and 1 to 8 carbon atoms, (R³O)ₘH or R⁴O[CO(CH₂)₅O]ₙH. Here, R³ represents an alkylene group having 2 to 4 carbon atoms, R⁴ represents an alkylene group having 1 to 8 carbon atoms, m represents an integer of 2 to 15, and n represents an integer of 1 to 15.]

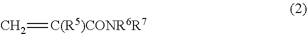

[where R⁵ represents a hydrogen atom or a methyl group, R⁶ represents a hydroxyl group or a hydroxyalkyl group having 1 to 8 carbon atoms, and R⁷ represents a hydrogen atom or a monovalent organic group.]

A proportion of the component (b) can be 0 mass % or more and 50 mass % or less with respect to all structural units of the present non-crosslinked polymer. The proportion of the component (b) may be 0.1 mass % or more and 40 mass % or less, 0.5 mass % or more and 30 mass % or less, 1.0 mass % or more and 20 mass % or less, 2 mass % or more and 12.5 mass % or less, or 3 mass % or more and 10 mass % or less. In addition, when the component (b) is contained in an amount of 0.1 mass % or more with respect to all the structural units of the present non-crosslinked polymer, since affinity to an electrolytic solution is improved, an effect of improving lithium ion conductivity can also be expected.

As the component (b), among components described above, the hydroxyl group-containing ethylenically unsaturated monomer is preferable from the viewpoint of excellent binding property of the binder containing the present non-crosslinked polymer salt.

Further, from the viewpoint of obtaining an electrode having good bending resistance, a structural unit derived from the nonionic ethylenically unsaturated monomer is preferable.

Examples of the nonionic ethylenically unsaturated monomer include (meth)acrylamide and derivatives thereof, nitrile group-containing ethylenically unsaturated monomers, and alicyclic structure-containing ethylenically unsaturated monomers.

A monomer represented by the formula (1) is a (meth)acrylate compound having a hydroxyl group. When R² is a monovalent organic group having a hydroxyl group and 1 to 8 carbon atoms, the number of hydroxyl groups may be only 1 or 2 or more. The monovalent organic group is not particularly limited, and examples thereof include an alkyl group optionally having a linear, branched or cyclic structure, an aryl group, and an alkoxyalkyl group. Further, when R² is (R³O)ₘH or R⁴O[CO(CH₂)₅O]ₙH, the alkylene group represented by R³ or R⁴ may be linear or branched.

Examples of the monomer represented by the formula (1) include: hydroxyalkyl (meth)acrylates having a hydroxyalkyl group having 1 to 8 carbon atoms, such as 2-hydroxyethyl (meth)acrylate, 3-hydroxypropyl (meth)acrylate, 4-hydroxybutyl (meth)acrylate, hydroxyhexyl (meth)acrylate, and hydroxyoctyl (meth)acrylate.; polyalkylene glycol mono(meth)acrylates such as polyethylene glycol mono(meth)acrylate, polypropylene glycol mono(meth)acrylate, polybutylene glycol mono(meth)acrylate, and polyethylene glycol-polypropylene glycol mono(meth)acrylate; dihydroxyalkyl (meth)acrylate such as glycerin mono(meth)acrylate; caprolactone-modified hydroxymethacrylate (trade names “PLACCEL FM1”, “PLACCEL FM5”, and the like manufactured by Daicel Corporation); and caprolactone-modified hydroxyacrylate (trade names “PLACCEL FA1”, “PLACCEL FA10L”, and the like manufactured by Daicel Corporation). The monomer represented by the formula (1) may be used alone, or two or more thereof may be used in combination.

A monomer represented by the formula (2) is a (meth)acrylamide derivative having a hydroxyl group or a hydroxyalkyl group having 1 to 8 carbon atoms. In the formula (2), R⁷ represents a hydrogen atom or a monovalent organic group. The monovalent organic group is not particularly limited, and examples thereof include an alkyl group optionally having a linear, branched or cyclic structure, an aryl group, and an alkoxyalkyl group, and an organic group having 1 to 8 carbon atoms is preferable. In addition, R⁷ may be a hydroxyl group or a hydroxyalkyl group having 1 to 8 carbon atoms.

Examples of the monomer represented by the formula (2) include: hydroxy (meth)acrylamide; (meth)acrylamide derivatives having a hydroxyalkyl group having 1 to 8 carbon atoms, such as N-hydroxyethyl (meth)acrylamide, N-(2-hydroxypropyl) (meth)acrylamide, N-hydroxybutyl (meth)acrylamide, N-hydroxyhexyl (meth)acrylamide, N-hydroxyoctyl (meth)acrylamide, N-methylhydroxyethyl (meth)acrylamide, and N-ethylhydroxyethyl (meth)acrylamide; and N,N-di-hydroxyalkyl (meth)acrylamide such as N,N-dihydroxyethyl (meth)acrylamide and N,N-dihydroxyethyl (meth)acrylamide. The monomer represented by the formula (2) may be used alone, or two or more thereof may be used in combination.

Examples of the (meth)acrylamide derivative include: N-alkyl (meth)acrylamide compounds such as N-isopropyl (meth)acrylamide and N-t-butyl (meth)acrylamide; N-alkoxyalkyl (meth)acrylamide compounds such as N-n-butoxymethyl (meth)acrylamide and N-isobutoxymethyl (meth)acrylamide; and N,N-dialkyl (meth)acrylamide compounds such as N,N-dimethyl (meth)acrylamide and N,N-diethyl (meth)acrylamide, and one of them may be used alone, or two or more thereof may be used in combination.

Examples of the nitrile group-containing ethylenically unsaturated monomer include: (meth)acrylonitrile; cyanoalkyl (meth)acrylate ester compounds such as cyanomethyl (meth)acrylate and cyanoethyl (meth)acrylate; cyano group-containing unsaturated aromatic compounds such as 4-cyanostyrene and 4-cyano-a-methylstyrene; and vinylidene cyanide, and one of them may be used alone, or two or more thereof may be used in combination. Among the above, acrylonitrile is preferable from the viewpoint of having a large nitrile group content.

Examples of the alicyclic structure-containing ethylenically unsaturated monomer include: (meth)acrylic acid cycloalkyl esters optionally having an aliphatic substituent such as cyclopentyl (meth)acrylate, cyclohexyl (meth)acrylate, methylcyclohexyl (meth)acrylate, t-butylcyclohexyl (meth)acrylate, cyclodecyl (meth)acrylate, and cyclododecyl (meth)acrylate; isobornyl (meth)acrylate; adamantyl (meth)acrylate; cyclopentenyl (meth)acrylate; dicyclopentenyloxyethyl (meth)acrylate; dicyclopentanyl (meth)acrylate; and cycloalkyl polyalcohol mono(meth)acrylates such as cyclohexanedimethanol mono(meth)acrylate and cyclodecanedimethanol mono (meth)acrylate, and one of them may be used alone, or two or more thereof may be used in combination.

The present non-crosslinked polymer preferably contains a structural unit derived from the monomer represented by the formula (1), the monomer represented by the formula (2), (meth)acrylamide and a derivative thereof, the nitrile group-containing ethylenically unsaturated monomer, the alicyclic structure-containing ethylenically unsaturated monomer, and the like from the viewpoint of excellent binding property of the binder. Among them, the component (b) is more preferably a structural unit derived from the monomer represented by the formula (1) and the monomer represented by the formula (2) from the viewpoint of being excellent in a binding property improving effect of the present binder.

Among monomers represented by the formula (1), hydroxyalkyl (meth)acrylate having a hydroxyalkyl group having 1 to 8 carbon atoms is more preferable, and 2-hydroxyethyl (meth)acrylate, 3-hydroxypropyl (meth)acrylate, and 4-hydroxybutyl (meth)acrylate are still more preferable. Further, among monomers represented by the formula (2), a (meth)acrylamide derivative having a hydroxyalkyl group having 1 to 8 carbon atoms is more preferable, and N-hydroxyethyl (meth)acrylamide, N-(2-hydroxypropyl) (meth)acrylamide, and N-hydroxybutyl (meth)acrylamide are still more preferable.

In addition, as the component (b), when a structural unit derived from a hydrophobic ethylenically unsaturated monomer having a solubility in water of 1 g/100 ml or less is introduced, a strong interaction with an electrode material can be obtained, and good binding property to the active material can be exhibited. Thus, since a rigid electrode mixture layer with good integrity can be obtained, as the “hydrophobic ethylenically unsaturated monomer having a solubility in water of 1 g/100 ml or less” described above, the alicyclic structure-containing ethylenically unsaturated monomer is particularly preferable.

Further, as other nonionic ethylenically unsaturated monomers, for example, (meth)acrylic acid ester may be used. Examples of the (meth)acrylic acid ester include: (meth)acrylic acid alkyl ester compounds such as methyl (meth)acrylate, ethyl (meth)acrylate, n-butyl (meth)acrylate, isobutyl (meth)acrylate, and 2-ethylhexyl (meth)acrylate; aromatic (meth)acrylic acid ester compounds such as phenyl (meth)acrylate, phenylmethyl (meth)acrylate, phenylethyl (meth)acrylate, and phenoxyethyl (meth)acrylate; and (meth)acrylic acid alkoxyalkyl ester compounds such as 2-methoxyethyl (meth)acrylate and 2-ethoxyethyl (meth)acrylate, and one of them may be used alone, or two or more thereof may be used in combination.

From the viewpoint of the binding property with the active material and cycle characteristics, an aromatic (meth)acrylic acid ester compound can be preferably used. From the viewpoint of further improving the lithium ion conductivity and high rate characteristics, compounds having an ether bond, such as (meth)acrylic acid alkoxyalkyl ester such as 2-methoxyethyl (meth)acrylate and 2-ethoxyethyl (meth)acrylate are preferable, and 2-methoxyethyl (meth)acrylate is more preferable.

Among the nonionic ethylenically unsaturated monomers, the compound having an acryloyl group is preferable from the viewpoint that the polymer having a long primary chain length is obtained due to a high polymerization rate and the binding force of the binder is improved. In addition, as the nonionic ethylenically unsaturated monomer, a compound having a glass transition temperature (Tg) of a homopolymer is 0° C. or lower is preferable from the viewpoint that the bending resistance of the obtained electrode is improved.

The present non-crosslinked polymer salt is in the form of a salt in which some or all of carboxyl groups contained in the polymer are neutralized. The type of salt is not particularly limited, and examples of the salt include: alkali metal salts such as a lithium salt, a sodium salt, and a potassium salt; alkaline earth metal salts such as a magnesium salt, a calcium salt, and a barium salt; other metal salts such as an aluminum salt; ammonium salts; and organic amine salts. Among them, from the viewpoint that adverse effects on battery characteristics are less likely to occur, alkali metal salts and alkaline earth metal salts are preferable, and alkali metal salts are more preferable.

### Properties of the Present Non-Crosslinked Polymer Salt

An acid group such as a carboxyl group derived from the ethylenically unsaturated carboxylic acid monomer is neutralized so that the degree of neutralization is 50 mol % or more in the present composition, and the present non-crosslinked polymer is used as a salt form. By setting the degree of neutralization to 50 mol % or more and increasing the glass transition temperature of the carboxyl group-containing non-crosslinked polymer, it is possible to suppress fusion and aggregation of the polymer due to heating when a composition for an electrode mixture layer containing the polymer is applied to the surface of the current collector and dried. This is presumed to have an effect of maintaining the structure in the electrode uniformly and further enhancing an effect of forming the conductive path by adding the CNT.

The degree of neutralization is more preferably 60 mol % or more, still more preferably 70 mol % or more, even still more preferably 75 mol % or more, yet still more preferably 80 mol % or more, and particularly preferably 85 mol % or more from the viewpoint that excellent charge/discharge capacity retention rate can be exhibited in use for a longer period of time than before. The upper limit value of the degree of neutralization is 100 mol %, and may be 98 mol % or 95 mol %. In the present specification, the degree of neutralization can be calculated from charged amount values of a monomer having an acid group such as a carboxyl group and a neutralizing agent used for neutralization. Note that the degree of neutralization can be confirmed from an intensity ratio of a peak derived from C═O group of a carboxylic acid to a peak derived from C═O group of a carboxylate by performing IR measurement of powders after the crosslinked polymer salt is dried at 80° C. for 3 hours under reduced pressure conditions.

A weight average molecular weight (Mw) of the present non-crosslinked polymer is not particularly limited, and is preferably 5,000 or more, and more preferably 10,000 or more from the viewpoint that excellent charge/discharge capacity retention rate can be exhibited in use for a longer period of time than before. Mw may be 100,000 or more, 500,000 or more, or 1,000,000 or more. The upper limit value of Mw is also not particularly limited, and may be, for example, 10,000,000 or less or 5,000,000 or less from the viewpoint of handling in production.

Note that in the present specification, Mw can be measured by the GPC method described in Examples.

### <Method for Producing the Present Non-Crosslinked Polymer>

As a method for producing the present non-crosslinked polymer, a known polymerization method (solution polymerization, precipitation polymerization, suspension polymerization, emulsion polymerization, and the like) can be used, and the method may be appropriately selected depending on the molecular weight, composition, or the like.

As a polymerization initiator, a known polymerization initiator such as an azo-based compound, an organic peroxide, or an inorganic peroxide can be used, but the polymerization initiator is not particularly limited. Use conditions can be adjusted so as to obtain an appropriate amount of radical generation by a known method such as thermal initiation, redox initiation using a reducing agent in combination, or UV initiation.

In addition, for the purpose of, for example, adjusting the molecular weight, a known chain transfer agent may be used as necessary.

Here, the present non-crosslinked polymer can contain 50 mass % or more and 100 mass % or less of the ethylenically unsaturated carboxylic acid monomer. The type of the ethylenically unsaturated carboxylic acid monomer is as described above.

### 3. Composition for Secondary Battery Electrode Mixture Layer

The composition for the secondary battery electrode mixture layer of the present invention contains the present binder, the carbon nanotube (CNT), the active material, and water.

An amount of the present binder used in the present composition is preferably 0.5 part by mass or more and 7.0 parts by mass or less with respect to 100 parts by mass of a total amount of the active material. The use amount is, for example, 0.8 part by mass or more and 3.0 parts by mass or less, for example, 1.0 part by mass or more and 2.5 parts by mass or less, or for example, 1.2 parts by mass or more and 1.5 parts by mass or less. When the amount of the binder used is 0.5 part by mass or more, sufficient binding property can be obtained. In addition, the dispersion stability of the active material and the like can be secured, and a uniform mixture layer can be formed. When the amount of the binder used is 1.5 parts by mass or less, the present composition does not have a high viscosity, and the coatability to the current collector can be secured. As a result, a mixture layer having a uniform and smooth surface can be formed.

An amount of the CNTs used in the present composition is, for example, 0.01 part by mass or more and 0.5 part by mass or less with respect to 100 parts by mass of the total amount of the active material. The use amount is, for example, 0.05 part by mass or more and 0.3 part by mass or less, or for example, 0.1 part by mass or more and 0.2 part by mass or less. When the content of the CNTs is 0.01 part by mass or more, a sufficient conductive path can be formed. When the content of the CNTs is 0.2 part by mass or less, the present composition does not have a high viscosity, and the coatability to the current collector can be secured. In addition, aggregation or the like of the CNTs does not occur, and as a result, an electrode having a uniform and smooth surface can be formed.

Among the above active materials, as a positive electrode active material, a lithium salt of a transition metal oxide can be used, and for example, layered rock salt-type and spinel-type lithium-containing metal oxides can be used. Specific examples of the layered rock salt-type positive electrode active material include lithium cobaltate, lithium nickelate, and NCM{Li(Niₓ,Co_{y},Mn_{z}), x+y+z=1} and NCA{Li(Ni_{1-a-b}COₐAl_{b})}, which are called ternary systems. Further, examples of the spinel-type positive electrode active material include lithium manganate. In addition to the oxides, phosphate, silicate, sulfur, and the like are used, and examples of the phosphate include olivine-type lithium iron phosphate. As the positive electrode active material, one of the above may be used alone, or two or more thereof may be used in combination as a mixture or a composite.

Note that when the positive electrode active material containing the layered rock salt-type lithium-containing metal oxide is dispersed in water, lithium ions on a surface of the active material and hydrogen ions in water are exchanged, and thus the dispersion liquid exhibits alkalinity. Therefore, aluminum foil (Al) or the like which is a general current collector material for a positive electrode may be corroded. In such a case, it is preferable to neutralize the alkali content eluted from the active material by using the unneutralized or partially neutralized present non-crosslinked polymer as the binder. In addition, an amount of the present non-crosslinked polymer which is not neutralized or partially neutralized used is preferably used such that an amount of unneutralized carboxyl groups of the present non-crosslinked polymer is equal to or more than an equivalent amount with respect to an amount of alkali eluted from the active material.

Since all positive electrode active materials have low electrical conductivity, a conductive auxiliary agent other than the carbon nanotubes may be added, and examples of the conductive auxiliary agent include carbon-based materials such as carbon black, carbon fiber, graphite fine powder, and carbon fiber, and among these, carbon black and carbon fiber are preferable from the viewpoint of easily obtaining excellent conductivity. Further, as the carbon black, Ketjen black and acetylene black are preferable. As the conductive auxiliary agent, one of the above-described ones may be used alone, or two or more thereof may be used in combination. From the viewpoint of achieving both conductivity and energy density, an amount of the conductive auxiliary agent other than the carbon nanotubes used can be, for example, 0.2 to 20 parts by mass, or for example, 0.2 to 10 parts by mass with respect to 100 parts by mass of the total amount of the active material. Further, a positive electrode active material surface-coated with a conductive carbon-based material may be used.

On the other hand, examples of a negative electrode active material include a carbon-based material, a lithium metal, a lithium alloy, and a metal oxide, and one type or two or more types thereof can be used in combination. Among them, the active materials (hereinafter, also referred to as “carbon-based active materials”) including carbon-based materials such as natural graphite, artificial graphite, hard carbon, and soft carbon are preferable, and graphites such as natural graphite and artificial graphite, and hard carbon are more preferable. In addition, in the case of graphite, spheroidized graphite is suitably used from the viewpoint of battery performance, and a preferable range of a particle size of the graphite is, for example, 1 to 20 μm, or for example, 5 to 15 μm.

In addition, in order to increase the energy density, a metal, a metal oxide, or the like, capable of absorbing lithium, such as silicon or tin can be used as the negative electrode active material. Among them, silicon has a higher capacity than graphite, and the active materials (hereinafter, also referred to as “silicon-based active materials”) including silicon-based materials such as silicon, a silicon alloy, and a silicon oxide such as silicon monoxide (SiO) can be used. From the viewpoint that electric capacity of the secondary battery can be increased, an amount of the silicon-based active material used can be 5.0 mass % or more, for example, 10.0 mass % or more, or for example, 20.0 mass % or more with respect to the total amount of the active material.

Since the carbon-based active material itself has good electrical conductivity, it is not always necessary to add the conductive auxiliary agent other than the carbon nanotubes. When the conductive auxiliary agent is added for the purpose of further reducing the resistance, or the like, a use amount thereof is, for example, 10 parts by mass or less, or for example, 5 parts by mass or less with respect to 100 parts by mass of the total amount of the active material from the viewpoint of the energy density.

When the present composition is in a slurry state, an amount of the active material used is, for example, in a range of 10 to 75 mass %, or for example, in a range of 30 to 65 mass % with respect to a total amount of the present composition. When the amount of the active material used is 10 mass % or more, migration of the binder and the like is suppressed, and it is also advantageous in terms of drying cost of a medium. On the other hand, when the amount of the active material used is 75 mass % or less, fluidity and coatability of the present composition can be secured, and a uniform mixture layer can be formed.

The present composition uses water as the medium. In addition, for the purpose of adjusting properties, drying properties, and the like of the present composition, a mixed solvent with a water-soluble organic solvent such as lower alcohols such as methanol and ethanol, carbonates such as ethylene carbonate, ketones such as acetone, tetrahydrofuran, or N-methyl-2-pyrrolidone may be used. A ratio of water in a mixed medium is, for example, 50 mass % or more, or for example, 70 mass % or more.

When the present composition is brought into a coatable slurry state, the content of the medium containing water in the entire present composition can be, for example, in the range of 25 to 60 mass %, or for example, 35 to 60 mass % from the viewpoint of coatability of the slurry, energy cost required for drying, and productivity.

The present composition may further contain other binder components such as styrene-butadiene rubber (SBR)-based latex, carboxymethylcellulose (CMC), acrylic latex, and polyvinylidene fluoride latex in combination. When another binder component is used in combination, a use amount thereof can be, for example, 0.1 to 5 parts by mass or less, for example, 0.1 to 2 parts by mass or less, or for example, 0.1 to 1 part by mass or less with respect to 100 parts by mass of the total amount of the active material. When an amount of the other binder component used exceeds 5 parts by mass, the resistance may increase, and the high-rate characteristics may be insufficient. Among the above, from the viewpoint of excellent balance between the binding property and the bending resistance, SBR-based latex and CMC are preferable, and SBR-based latex and CMC are more preferably used in combination.

The SBR-based latex refers to an aqueous dispersion of a copolymer having a structural unit derived from an aromatic vinyl monomer such as styrene and a structural unit derived from an aliphatic conjugated diene-based monomer such as 1,3-butadiene. Examples of the aromatic vinyl monomer include α-methylstyrene, vinyltoluene, and divinylbenzene in addition to styrene, and one or two or more thereof can be used. The structural unit derived from the aromatic vinyl monomer in the copolymer can be, for example, in the range of 20 to 70 mass %, or for example, in the range of 30 to 60 mass %, mainly from the viewpoint of the binding property.

Examples of the aliphatic conjugated diene-based monomer include 2-methyl-1,3-butadiene, 2,3-dimethyl-1,3-butadiene, and 2-chloro-1,3-butadiene in addition to 1,3-butadiene, and one or two or more thereof can be used. The structural unit derived from the aliphatic conjugated diene-based monomer in the copolymer can be, for example, in the range of 30 to 70 mass %, or for example, in the range of 40 to 60 mass % from the viewpoint that the binding property of the binder and flexibility of the obtained electrode are good.

Regarding a styrene-butadiene-based latex, in order to further improve performance such as the binding property, in addition to the above-described monomers, a nitrile group-containing monomer such as (meth)acrylonitrile, a carboxyl group-containing monomer such as (meth)acrylic acid, itaconic acid, or maleic acid, or an ester group-containing monomer such as methyl (meth)acrylate, as another monomer, may be used as a copolymer monomer.

The structural unit derived from the other monomer in the copolymer can be, for example, in a range of 0 to 30 mass %, or for example, in a range of 0 to 20 mass %.

The CMC refers to a substituted product obtained by substituting a nonionic cellulose-based semi-synthetic polymer compound with a carboxymethyl group, and a salt thereof. Examples of the nonionic cellulose-based semi-synthetic polymer compound include: alkyl celluloses such as methyl cellulose, methyl ethyl cellulose, ethyl cellulose, and microcrystalline cellulose; and hydroxyalkyl celluloses such as hydroxyethyl cellulose, hydroxybutyl methyl cellulose, hydroxypropyl cellulose, hydroxypropyl methyl cellulose, hydroxyethyl methyl cellulose, hydroxypropyl methyl cellulose stearoxy ether, carboxymethyl hydroxyethyl cellulose, alkyl hydroxyethyl cellulose, and nonoxynyl hydroxyethyl cellulose.

The composition for the secondary battery electrode mixture layer of the present invention contains the binder, the CNT, the active material, and water as essential components, and is obtained by mixing the components using known means. A method for mixing the components is not particularly limited, and a known method can be adopted, but a method is preferable in which powder components such as the active material, the conductive auxiliary agent, and the binder are dry-blended, then mixed with a dispersion medium such as water, and dispersed and kneaded. When the present composition is obtained in the slurry state, it is preferable to finish the composition into a slurry having no poor dispersion or aggregation. As a mixing means, a known mixer such as a planetary mixer, a thin-film swirling mixer, or a rotation-revolution mixer can be used, but it is preferable to use the thin-film swirling mixer from the viewpoint that a good dispersion state can be obtained in a short time. In addition, in the case of using the thin-film swirling mixer, it is preferable to perform preliminary dispersion in advance with a stirrer such as a disperser. The pH of the slurry is not particularly limited as long as the effect of the present invention is obtained, but is preferably less than 12.5, and for example, in the case of blending the CMC, the pH is more preferably less than 11.5, and still more preferably less than 10.5 from the viewpoint that concern of hydrolysis of the CMC is small. Further, the viscosity of the slurry is not particularly limited as long as the effect of the present invention is obtained, but the B-type viscosity (25° C.) at 20 rpm can be, for example, in the range of 100 to 30,000 mPa's, for example, in the range of 500 to 20,000 mPa·s, or for example, in the range of 1,000 to 10,000 mPa s. When the viscosity of the slurry is within the above range, good coatability can be secured.

### 4. Secondary Battery Electrode

The secondary battery electrode of the present invention includes a mixture layer formed from the composition for the secondary battery electrode mixture layer of the present invention on the surface of the current collector such as copper, aluminum, or the like. The mixture layer is formed by applying the present composition to the surface of the current collector and then drying and removing the medium such as water. The method for applying the present composition is not particularly limited, and known methods such as a doctor blade method, a dip method, a roll coating method, a comma coating method, a curtain coating method, a gravure coating method, and an extrusion method can be employed. Further, the drying can be performed by a known method such as warm air blowing, decompression, (far) infrared ray irradiation, or microwave irradiation.

Usually, the mixture layer obtained after drying is subjected to compression treatment by a die press, a roll press, or the like. By compressing, the active material and the binder can be brought into close contact with each other, and strength of the mixture layer and adhesion to the current collector can be improved. A thickness of the mixture layer can be adjusted by compression to, for example, about 30 to 80% of that before compression, and the thickness of the mixture layer after compression is generally about 4 to 200 μm.

### 5. Secondary Battery

The secondary battery can be produced by providing the secondary battery electrode of the present invention with a separator and the electrolytic solution. The electrolytic solution may be liquid or gel.

The separator is disposed between the positive electrode and the negative electrode of the battery, and plays a role of preventing a short circuit due to contact between both electrodes and holding the electrolytic solution to secure the ion conductivity. The separator is preferably a film-like insulating microporous membrane having good ion permeability and mechanical strength. As a specific material, polyolefins such as polyethylene and polypropylene, polytetrafluoroethylene, and the like can be used.

As the electrolytic solution, a known electrolytic solution that is generally used can be used depending on the type of the active material. In a lithium ion secondary battery, specific examples of the solvents include cyclic carbonates having a high dielectric constant and a high electrolyte dissolving ability such as propylene carbonate and ethylene carbonate, and chain carbonates having a low viscosity such as ethyl methyl carbonate, dimethyl carbonate, and diethyl carbonate, and they can be used alone or as a mixed solvent. The electrolytic solution is used by dissolving a lithium salt such as LiPF₆, LiSbF₆, LiBF₄, LiClO₄, or LiAlO₄ in these solvents. In the nickel-hydrogen hydride secondary battery, a potassium hydroxide aqueous solution can be used as the electrolytic solution. The secondary battery is obtained by forming a positive electrode plate and a negative electrode plate separated by the separator into a spiral shape or a laminated structure and storing them in a case or the like.

The binder for the secondary battery electrode disclosed in the present specification is excellent in toughness of a binder coating film after immersion in the electrolytic solution, and the secondary battery electrode mixture layer obtained using the electrode slurry containing the binder exhibits electrolytic solution resistance. Furthermore, the secondary battery including an electrode obtained using the binder can ensure good integrity, and exhibits good durability (cycle characteristics) even when charging and discharging are repeated, and thus is suitable for a vehicle-mounted secondary battery and the like.

### EXAMPLES

Hereinafter, the present invention will be specifically described based on Examples. Note that the present invention is not limited to these Examples. Note that in the following description, “parts” and “%” respectively mean parts by mass and mass % unless otherwise specified.

### <<Production of the Present Non-Crosslinked Polymer Salt>>

### <Measurement of Molecular Weight of Carboxyl Group-Containing Non-Crosslinked Polymer>

0.1 g of an aqueous solution containing a carboxyl group-containing non-crosslinked polymer (0.01 g as the solid content of the polymer) was collected and diluted with 40 g of a 0.1M aqueous sodium nitrate solution to obtain a measurement sample.

The measurement sample was measured by a gel permeation chromatography (GPC) method under conditions described below to obtain the weight average molecular weight (Mw) in terms of sodium polyacrylate.

### (GPC Measurement Conditions)

Column: TSKgel GMPW manufactured by Tosoh Corporation×2 columns
Solvent: 0.1M aqueous sodium nitrate solution
Temperature: 40° C.
Detector: RI
Flow rate: 0.5 mL/min

### Production Example 1: Production of Carboxyl Group-Containing Non-Crosslinked Polymer Salt R-1

Lithium hydroxide monohydrate in an amount corresponding to 90 mol % of carboxylic acid and pure water were added to a 20 mass % aqueous solution of polyacrylic acid (manufactured by Toagosei Co., Ltd., product name “Jurimer (registered trademark) AC-10H”) to obtain a 12 mass % aqueous solution R-1 of carboxyl group-containing non-crosslinked polymer salt (lithium polyacrylate).

### Production Example 2: Production of Carboxyl Group-Containing Non-Crosslinked Polymer Salt R-2

A 12 mass % aqueous solution of carboxyl group-containing non-crosslinked polymer salt (lithium polyacrylate) R² was obtained by performing the same operation as in Production Example 1 except that the carboxyl group-containing non-crosslinked polymer and the degree of neutralization were as shown in Table 1.

### Production Examples 3 to 5 and Comparative Production Example 1: Production of Carboxyl Group-Containing Non-Crosslinked Polymer Salts R-2 to R-5 and R-7

12 mass % aqueous solutions of carboxyl group-containing non-crosslinked polymer salts (lithium polyacrylate) R-3 to R-5 and R-7 were obtained by performing the same operation as in Production Example 1 except that the degree of neutralization was as shown in Table 1.

### Production Example 6: Production of Carboxyl Group-Containing Non-Crosslinked Polymer Salt R-6

For the polymerization, a reactor equipped with a stirring blade, a thermometer, a reflux condenser, and a nitrogen inlet tube was used.

The reactor was charged with 132.1 parts of ion-exchanged water, 51.9 parts of acrylic acid (hereinafter, referred to as “AA”), and 48.1 parts of 2-hydroxyethyl acrylate (hereinafter, referred to as “HEA”). An inside of the reactor was sufficiently purged with nitrogen, and then heated to raise an internal temperature to 80° C. After confirming that the internal temperature was stabilized at 80° C., when 1.5 parts of ammonium peroxodisulfate was added as a polymerization initiator, heat generation inside the reaction was observed, and thus this point was defined as a polymerization initiation point. The polymerization reaction was continued while maintaining the internal temperature at 80° C. by adjusting an external temperature (a water bath temperature), cooling of the reaction solution was started at a time point when 5 hours had elapsed from the polymerization initiation point, and after the internal temperature decreased to 25° C., 27.2 parts of a powder of lithium hydroxide monohydrate (hereinafter, referred to as “LiOH·H₂O”) was added. After the addition, stirring was continued at room temperature for 12 hours to obtain a 12 mass % aqueous solution of carboxyl group-containing non-crosslinked polymer salt R-6 (Li salt, degree of neutralization: 90 mol %). The weight average molecular weight of R-6 was 150,000.

TABLE 1

| | | | Production Example and Comparative Production Example No. | | | | | | |
|---|---|---|---|---|---|---|---|---|---|
| | | | | | | | | | Comparative |
| | | | Production | Production | Production | Production | Production | Production | Production |
| | | | Example 1 | Example 2 | Example 3 | Example 4 | Example 5 | Example 6 | Example 1 |
| Carboxyl group-containing | | | R-1 | R-2 | R-3 | R-4 | R-5 | R-6 | R-7 |
| non-crosslinked polymer salt | | | | | | | | | |
| Preparation | Carboxyl group- | Type | AC-10H | AC-10L | AC-10H | AC-10H | AC-10H | — | AC-10H |
| [parts] | containing non- | parts | 100.0 | 100.0 | 100.0 | 100.0 | 100.0 | — | 100.0 |
| | crosslinked | | | | | | | | |
| | polymer | | | | | | | | |
| | Monomer | AA | — | — | — | — | — | 51.9 | — |
| | | HEA | — | — | — | — | — | 48.1 | — |
| | Ion-exchanged water | | — | — | — | — | — | 132.1 | — |
| | Initiator | Ammonium | — | — | — | — | — | 1.5 | — |
| | | peroxodisulfate | | | | | | | |
| | Neutralization | LiOH•H₂O | 52.4 | 52.4 | 46.6 | 34.9 | | 27.2 | 26.2 |
| | | NaOH | | | | | 49.9 | | |

| | | | | | | | | |
|---|---|---|---|---|---|---|---|---|
| Neutralization | Type | Li | Li | Li | Li | Na | Li | Li |
| salt | Degree of | 90.0% | 90.0% | 80.0% | 60.0% | 90.0% | 90.0% | 45.0% |
| | neutralization [mol %] | | | | | | | |

Details of compounds used in Table 1 are shown below.
AC-10H: 20 mass % aqueous solution of polyacrylic acid (weight average molecular weight of 800,000) (manufactured by Toagosei Co., Ltd., product name “Jurimer (registered trademark) AC-10H”)
AC-10L: 40 mass % aqueous solution of polyacrylic acid (weight average molecular weight of 60,000) (manufactured by Toagosei Co., Ltd., product name “Jurimer (registered trademark) AC-10L”)
AA: acrylic acid
HEA: 2-hydroxyethyl acrylate
LiOH·H₂O: lithium hydroxide monohydrate
NaOH: sodium hydroxide

### Example 1

### (Preparation of Composition for Electrode Mixture Layer (Electrode Slurry))

As the active material, artificial graphite (trade name “SCMG-CF” manufactured by Showa Denko K.K.) and SiO (5 μm manufactured by OSAKA Titanium technologies Co., Ltd.) were used. As the binder, a mixture of crosslinked polymer R-1, styrene-butadiene-based latex (SBR), and sodium carboxymethylcellulose (CMC) was used. As the conductive auxiliary agent, the single-walled CNT (trade name “TuballBATT H₂O” (solvent: water, single-walled CNT content: 0.4 mass %) manufactured by OCSiAl) was used.

Artificial graphite, SiO, crosslinked polymer salt R-1, SBR, CMC, and single-walled CNT were added using water as a diluting solvent to a planetary mixer (HIVIS MIX 2P-03 type manufactured by PRIMIX Corporation) at a mass ratio of artificial graphite:SiO:non-crosslinked olymer salt R-1:SBR:CMC:single-walled CNT=77.6:19.4:1.0:2.0:1.0:0.1 (solid content) so that the solid content concentration of the composition for the electrode mixture layer was 53 mass %, and the mixture was mixed for 1 hour and 30 minutes to prepare a composition for an electrode mixture layer in a slurry state (electrode slurry).

### (Preparation of Negative Electrode Plate)

Subsequently, the electrode slurry was applied onto a current collector (copper foil) having a thickness of 16.5 μm using a variable applicator, and dried in a ventilation dryer at 80° C. for 15 minutes to form a mixture layer. Thereafter, the mixture layer was rolled so as to have a thickness of 50+5 μm and a mixture density of 1.60±0.10 g/cm³, and then punched into a 3 cm square to obtain a negative electrode plate for battery evaluation.

### (Preparation of Positive Electrode Plate)

In an N-methylpyrrolidone (NMP) solvent, 100 parts of LiNi_{0.5}Co_{0.2}Mn_{0.3}O₂ (NCM) as a positive electrode active material and 2 parts of acetylene black were mixed and added, and 4 parts of polyvinylidene fluoride (PVDF) as a binder for a positive electrode were mixed to prepare a composition for a positive electrode mixture layer. The composition for the positive electrode mixture layer was applied to an aluminum current collector (thickness: 20 μm) and dried to form a mixture layer. Thereafter, the mixture layer was rolled so as to have a thickness of 125 μm and a mixture density of 3.0 g/cm³, and then punched into a 3 cm square to obtain a positive electrode plate for battery evaluation.

### (Preparation of Electrolytic Solution)

Vinylene carbonate (VC) and fluoroethylene carbonate (FEC) were respectively added to be 1 mass % and 2 mass % to a mixed solvent containing ethylene carbonate (EC) and dimethyl carbonate (DMC) (EC:DMC=3:7 by volume), and 1.2 mol/L of LiPF₆ was dissolved to prepare a nonaqueous electrolyte.

### (Preparation of Secondary Battery)

For configuration of the battery, a lead terminal was attached to each of the positive and negative electrodes, and electrode bodies opposed to each other with a separator (made of polyethylene: film thickness 16 μm, porosity 47%) interposed therebetween were placed in a battery exterior body using an aluminum laminate, injected with liquid, and sealed to obtain a test battery. Note that a design capacity of this prototype battery is 50 mAh. The design capacity of the battery was designed based on an end-of-charge voltage up to 4.2 V.

### <Evaluation of Cycle Characteristics>

The lithium ion secondary battery of a laminate type cell prepared above was subjected to a charge/discharge operation at a charge/discharge rate of 0.1 C under a condition of 2.5 to 4.2 V by CC discharge under an environment of 45° C., and an initial capacity Co was measured. Further, charge and discharge were repeated at a charge/discharge rate of 0.5 C under the condition of 2.5 to 4.2 V by CC discharge under the environment of 45° C., and a capacity C₁₀₀ after 100 cycles and a capacity C₃₀₀ after 300 cycles were measured.

Here, the cycle characteristics (AC) were determined by the following formula.

$$Charge / discharge capacity retention rate after 100 cycles Δ {C}_{100} = {C}_{100} / {C}_{0} \times 100 ( \% )$$

$$Charge / discharge capacity retention rate after 300 cycles Δ {C}_{300} = {C}_{100} / {C}_{0} \times 100 ( \% )$$

ΔC₁₀₀ calculated by the above formula was 91.2%, and the cycle characteristics based on the following criteria were evaluated as “A”.

In addition, ΔC₃₀₀ calculated by the above formula was 83.1%, and the cycle characteristics based on the following criteria were evaluated as “A”.

Note that a higher AC value indicates more excellent cycle characteristics. (Criteria for determining cycle characteristics ΔC₁₀₀)
A: Charge/discharge capacity retention rate is 90% or more
B: Charge/discharge capacity retention rate is 80% or more and less than 90%
C: Charge/discharge capacity retention rate is 70% or more and less than 80%
D: Charge/discharge capacity retention rate is less than 70%

### (Criteria for Determining Cycle Characteristics ΔC₃₀₀)

A: Charge/discharge capacity retention rate is 80% or more
B: Charge/discharge capacity retention rate is 70% or more and less than 80%
C: Charge/discharge capacity retention rate is 60% or more and less than 70%
D: Charge/discharge capacity retention rate is less than 60%

### <Evaluation of Expansion Rate of Electrode>

The lithium ion secondary battery of the laminate type cell for which a cycle test was performed 300 times as described above was disassembled, to recover the negative electrode. Each of recovered negative electrodes was washed with a dimethyl carbonate (DMC) solvent, naturally dried at normal temperature for 1 day, and then the thickness was measured. Thus, the expansion rate of the negative electrode was calculated by substituting the measured thickness into the following formula.

$$[ Expansion rate ( \% ) of electrode ] = 100 \times \{ ( thickness of discharge negative electrode of battery ) - ( thickness of copper foil ) \} / \{ ( thickness of negative electrode before assembly ) - ( thickness of copper foil ) \}$$

The expansion rate of the electrode calculated by the above formula was 168%, and the expansion rate based on the following criteria was evaluated as “A”.

Note that the lower a value of the expansion rate of the electrode, the more an effect of suppressing expansion of the electrode is exhibited, which indicates that the battery performance is excellent.

### (Criteria for Determining Expansion Rate of Electrode)

A: Expansion rate of electrode is less than 180%
B: Expansion rate of electrode is 180% or more and less than 200%
C: Expansion rate of electrode is 200% or more and less than 250%
D: Expansion rate of electrode is 250% or more

### Examples 2 to 15 and Comparative Examples 1 and 2

An electrode slurry was prepared by performing the same operation as in Example 1 except for using formulation shown in Table 2. The cycle characteristics and the expansion rate of the electrode of the battery of the negative electrode plate obtained using each electrode slurry were evaluated, and results are shown in Table 2.

TABLE 2

| | | | | Example and Comparative Example No. | | | | | | | | |
|---|---|---|---|---|---|---|---|---|---|---|---|---|
| | | | | Exam- | Exam- | Exam- | Exam- | Exam- | Exam- | Exam- | Exam- | Exam- |
| | | | | ple 1 | ple 2 | ple 3 | ple 4 | ple 5 | ple 6 | ple 7 | ple 8 | ple 9 |
| Compo- | Active | Artificial | parts | 77.6 | 77.6 | 77.6 | 77.6 | 77.6 | 77.6 | 77.6 | 77.6 | 77.6 |
| sition for | material | graphite | | | | | | | | | | |
| electrode | | SiO | parts | 19.4 | 19.4 | 19.4 | 19.4 | 19.4 | 19.4 | 19.4 | 19.4 | 19.4 |
| mixture | Binder | Carboxyl | Type | R-1 | R-1 | R-2 | R-3 | R-4 | R-5 | R-6 | R-1 | R-1 |
| layer | | group- | Degree of | 90 | 90 | 90 | 80 | 60 | 90 | 90 | 90 | 90 |
| (Electrode | | containing | neutral- | | | | | | | | | |
| slurry) | | non- | ization | | | | | | | | | |
| | | cross- | [mol %] | | | | | | | | | |
| | | linked | parts | 1 | 1 | 1 | 1 | 1 | 1 | 1 | 0.5 | 1.5 |
| | | polymer | | | | | | | | | | |
| | | salt | | | | | | | | | | |
| | | SBR | parts | 2 | 2 | 2 | 2 | 2 | 2 | 2 | 2 | 2 |
| | | CMC | parts | 1 | 1 | 1 | 1 | 1 | 1 | 1 | 1 | 1 |

| | | | | | | | | | | |
|---|---|---|---|---|---|---|---|---|---|---|
| Conductive | Type | Single- | Single- | Single- | Single- | Single- | Single- | Single- | Single- | Single- |
| auxiliary | | walled | walled | walled | walled | walled | walled | walled | walled | walled |
| agent | | CNT | CNT | CNT | CNT | CNT | CNT | CNT | CNT | CNT |

| | | | | | | | | | |
|---|---|---|---|---|---|---|---|---|---|
| parts | 0.1 | 0.05 | 0.1 | 0.1 | 0.1 | 0.1 | 0.1 | 0.1 | 0.1 |

| | | | | | | | | | | |
|---|---|---|---|---|---|---|---|---|---|---|
| Evalu- | Capacity retention | A | A | A | A | A | A | A | A | A |
| ation | rate after 100 | | | | | | | | | |
| results | cycles ΔC₁₀₀ | | | | | | | | | |
| | Capacity retention | A | C | B | A | B | A | C | C | A |
| | rate after 300 | | | | | | | | | |
| | cycles ΔC₃₀₀ | | | | | | | | | |
| | Expansion rate | A | B | A | A | A | A | C | C | B |
| | of electrode | | | | | | | | | |

| | | | | Example and Comparative Example No. | | | | | | | |
|---|---|---|---|---|---|---|---|---|---|---|---|
| | | | | | | | | | | Compar- | Compar- |
| | | | | | | | | | | ative | ative |
| | | | | Exam- | Exam- | Exam- | Exam- | Exam- | Exam- | Exam- | Exam- |
| | | | | ple 10 | ple 11 | ple 12 | ple 13 | ple 14 | ple 15 | ple 1 | ple 2 |
| Compo- | Active | Artificial | parts | 77.6 | 77.6 | 77.6 | 67.9 | 87.3 | 92.15 | 77.6 | 77.6 |
| sition for | material | graphite | | | | | | | | | |
| electrode | | SiO | parts | 19.4 | 19.4 | 19.4 | 29.1 | 9.7 | 4.85 | 19.4 | 19.4 |
| mixture | Binder | Carboxyl | Type | R-2 | R-1 | R-2 | R-1 | R-1 | R-1 | R-7 | — |
| layer | | group- | Degree of | 90 | 90 | 90 | 90 | 90 | 90 | 45 | — |
| (Electrode | | containing | neutral- | | | | | | | | |
| slurry) | | non- | ization | | | | | | | | |
| | | cross- | [mol %] | | | | | | | | |
| | | linked | parts | 1.5 | 3 | 3 | 1 | 1 | 2 | 1 | 0 |
| | | polymer | | | | | | | | | |
| | | salt | | | | | | | | | |
| | | SBR | parts | 2 | 2 | 2 | 2 | 2 | 2 | 2 | 2 |
| | | CMC | parts | 1 | 1 | 1 | 1 | 1 | 1 | 1 | 1 |

| | | | | | | | | | |
|---|---|---|---|---|---|---|---|---|---|
| Conductive | Type | Single- | Single- | Single- | Single- | Single- | Single- | Single- | Single- |
| auxiliary | | walled | walled | walled | walled | walled | walled | walled | walled |
| agent | | CNT | CNT | CNT | CNT | CNT | CNT | CNT | CNT |

| | | | | | | | | |
|---|---|---|---|---|---|---|---|---|
| parts | 0.1 | 0.1 | 0.1 | 0.1 | 0.1 | 0.1 | 0.1 | 0.1 |

| | | | | | | | | | |
|---|---|---|---|---|---|---|---|---|---|
| Evalu- | Capacity retention | A | A | A | A | A | A | B | A |
| ation | rate after 100 | | | | | | | | |
| results | cycles ΔC₁₀₀ | | | | | | | | |
| | Capacity retention | B | C | C | B | A | A | D | D |
| | rate after 300 | | | | | | | | |
| | cycles ΔC₃₀₀ | | | | | | | | |
| | Expansion rate | B | B | B | B | A | A | D | D |
| | of electrode | | | | | | | | |

Details of compounds used in Table 2 are shown below.
SBR: styrene-butadiene rubber
CMC: sodium carboxymethylcellulose
AB: acetylene black

### <<Evaluation Results>>

As is apparent from the results of Examples 1 to 15, the secondary battery including the electrode obtained by using the composition for the secondary battery electrode mixture layer (electrode slurry) of the present invention was not only excellent in capacity retention rate at 100 cycles, but also exhibited a high capacity retention rate even in use at a high number of charge/discharge of 300 cycles. In addition, an effect of suppressing expansion of the negative electrode after the test was also observed.

This is considered to be because as the molecular weight of the non-crosslinked polymer is higher, the active materials can be more strongly bound, and an electrode structure can be maintained even in long-term use.

Among them, when a use amount of the carbon nanotubes was compared, a case of 0.1 part by mass (Example 1) with respect to 100 parts by mass of the total amount of the active materials showed a result that the capacity retention rate at 300 cycles and the effect of suppressing expansion were more excellent than those of a case where an amount of the single-walled CNT used was 0.05 part by mass (Example 2).

This is considered to be an effect that, with respect to an increase in distance between the active materials due to expansion of the negative electrode due to repeated charging and discharging, as the use amount of the carbon nanotubes having a high aspect ratio structure increases, the number of places where the conductive path is formed increases, and the capacity is less likely to deteriorate.

Focusing on the molecular weight of the carboxyl group-containing non-crosslinked polymer, in comparison between Examples 1 and 3, the case of using a carboxyl group-containing non-crosslinked polymer having a higher molecular weight (Example 1) resulted in excellent battery characteristics.

Focusing on the degree of neutralization of the carboxyl group-containing non-crosslinked polymer, the results showed that the battery performance was more excellent when the degree of neutralization of the polymer was 80 mol % (Example 4) than when the degree of neutralization of the polymer was 60 mol % (Example 5).

This is considered to be because the higher the degree of neutralization of the carboxyl group-containing non-crosslinked polymer, the higher the glass transition point of the polymer, fusion of the polymer is suppressed in a heating and drying step in an electrode preparation step, and a uniform electrode can be obtained.

On the other hand, when the degree of neutralization of the carboxyl group-containing non-crosslinked polymer was 45 mol % (Comparative Example 1), the capacity retention rate at the time of 100 cycles was slightly poor, and in addition, the capacity retention rate at the time of 300 cycles after charging and discharging were further repeated was significantly reduced.

This is considered to be because due to fusion of the carboxyl group-containing non-crosslinked polymer, structural uniformity in the mixture layer was deteriorated at the time of electrode preparation, and stress concentration was locally generated along with suppression of expansion of the active material due to charge and discharge, thereby leading to destruction of the electrode structure.

When a neutralization salt was changed to Na salt (Example 6), the same battery performance was shown as when the neutralization salt was Li salt (Example 1).

This is considered to be because the neutralization salt of the non-crosslinked polymer exhibits the same binding property and rigidity regardless of the kind under the environment of 45° C.

Focusing on the content of the structural unit derived from the ethylenically unsaturated carboxylic acid monomer, the results showed that the battery characteristics were more excellent in a case where the content was 100 mass % (Example 1) than a case where the content was 52 mass % (Example 7).

This is considered to be because the larger the content of the carboxyl group in the non-crosslinked polymer, the more excellent the binding property with the active material, so that destruction of an electrode structure can be suppressed even in long-term use of the battery.

Comparison of the amount of the carboxyl group-containing non-crosslinked polymer salt used showed that the case where the amount of the carboxyl group-containing non-crosslinked polymer salt used is 1.0 part by mass (Example 1) with respect to 100 parts by mass of the total amount of the active materials was more excellent in the capacity retention rate at the time of 300 cycles and the effect of suppressing expansion than the cases where the amount of the carboxyl group-containing non-crosslinked polymer salt used is 0.5 part by mass (Example 8), 1.5 parts by mass (Examples 9 and 10), and 3.0 parts by mass (Examples 11 and 12).

The smaller the amount of the carboxyl group-containing non-crosslinked polymer salt used, the smaller the number of binding points in the electrode, and thus the increase in the distance between the active materials due to the high number of cycles of charge and discharge is likely to occur. In addition, it is considered to be because as the amount of the carboxyl group-containing non-crosslinked polymer salt used increases, the number of binding points increases, but brittleness of the polymer affects physical properties of the electrode, and the electrode is easily affected by stress due to expansion and shrinkage of the active material, which leads to deterioration.

Regarding the amount of the silicon-based active material used, even when it was increased from Example 1 to 29.1 parts by mass (Example 13), and when it was decreased from Example 1 to 9.7 parts by mass (Example 14) or 4.9 parts by mass (Example 15), good capacity retention rate and the effect of suppressing expansion were exhibited.

This is considered to be because by using the present non-crosslinked polymer salt and the single-walled CNT in combination, it is possible to repeatedly perform charging and discharging while suppressing structural breakdown and conductive path disconnection in the mixture layer regardless of the amount of the silicon-based active material used.

On the other hand, in a case where the carboxyl group-containing non-crosslinked polymer salt was not used (Comparative Example 2), the results showed that although a good cycle retention rate was shown at the time of 100 cycles, the capacity was significantly deteriorated after 300 cycles of repeated charge and discharge.

This is considered to be because at the time of 100 cycles, the conductive path between the active materials is maintained and the capacity is maintained due to good conductivity of the single-walled CNT, but when the non-crosslinked polymer salt is not used, the binding force is greatly inferior, and thus the distance between the active materials also increases as the number of repeated charge and discharge increases, and the conductive path by the single-walled CNT is also cut, which leaded to capacity deterioration.

### INDUSTRIAL APPLICABILITY

A secondary battery including an electrode obtained using the binder for the secondary battery electrode disclosed in the present specification can ensure good integrity, and exhibits good durability (cycle characteristics) even when charging and discharging are repeated while suppressing expansion and shrinkage due to charging and discharging in use for a longer period of time than before, and thus is expected to contribute to increasing capacity of an in-vehicle secondary battery or the like.

The binder for the secondary battery electrode of the present invention can be particularly suitably used for a nonaqueous electrolyte secondary battery electrode, and is particularly useful for a nonaqueous electrolyte lithium ion secondary battery having high energy density.

1. A binder for an electrode of a secondary battery provided with a secondary battery electrode containing carbon nanotubes, the binder for the electrode comprising a carboxyl group-containing non-crosslinked polymer or a salt of the non-crosslinked polymer, wherein a degree of neutralization of the polymer is 50 mol % or more.

2. The binder for the electrode according to claim 1, wherein the carboxyl group-containing non-crosslinked polymer contains a structural unit derived from an ethylenically unsaturated carboxylic acid monomer in an amount of 50 mass % or more and 100 mass % or less with respect to all structural units of the carboxyl group-containing non-crosslinked polymer.

3. A composition for a secondary battery electrode mixture layer, the composition comprising the binder for the electrode according to claim 1, a carbon nanotube, an active material, and water.

4. The composition for the secondary battery electrode mixture layer according to claim 3, wherein a content of a silicon active material is 5.0 mass % or more with respect to a total amount of the active material.

5. The composition for the secondary battery electrode mixture layer according to claim 3, wherein a content of the binder for the electrode is 1.0 part by mass or more and 2.5 parts by mass or less with respect to 100 parts by mass of a total amount of the active material.

6. The composition for the secondary battery electrode mixture layer according to claim 3, wherein a content of the carbon nanotube is 0.1 part by mass or more with respect to 100 parts by mass of a total amount of the active material.

7. The composition for the secondary battery electrode mixture layer according to claim 3, wherein the carbon nanotube has a single-layer structure.

8. A secondary battery electrode comprising a mixture layer formed from the composition for the secondary battery electrode mixture layer according to claim 3 on a surface of a current collector.

9. A secondary battery comprising the secondary battery electrode according to claim 8.

10. A composition for a secondary battery electrode mixture layer, the composition comprising the binder for the electrode according to claim 2, a carbon nanotube, an active material, and water.

11. The composition for the secondary battery electrode mixture layer according to claim 10, wherein a content of a silicon active material is 5.0 mass % or more with respect to a total amount of the active material.

12. The composition for the secondary battery electrode mixture layer according to claim 10, wherein a content of the binder for the electrode is 1.0 part by mass or more and 2.5 parts by mass or less with respect to 100 parts by mass of a total amount of the active material.

13. The composition for the secondary battery electrode mixture layer according to claim 10, wherein a content of the carbon nanotube is 0.1 part by mass or more with respect to 100 parts by mass of a total amount of the active material.

14. The composition for the secondary battery electrode mixture layer according to claim 10, wherein the carbon nanotube has a single-layer structure.

15. A secondary battery electrode comprising a mixture layer formed from the composition for the secondary battery electrode mixture layer according to claim 10 on a surface of a current collector.

16. A secondary battery comprising the secondary battery electrode according to claim 15.
